(19) United States
(12) Patent Application Publication
(10) Pub. No.: US 2011/0185388 A1
(43) Pub. Date: Jul. 28, 2011

(54) APPARATUS AND METHODS FOR PRIORITIZING CONTENT RECEPTION IN A DIGITAL VIDEO RECORDER

(75) Inventor: Max S. Gratton, Lakewood, CO (US)

(73) Assignee: DISH NETWORK LLC, Englewood, CO (US)

(21) Appl. No.: 12/692,928

(22) Filed: Jan. 25, 2010

(51) Int. Cl. H04N 5/445; G06F 13/10; H04N 5/50

(52) U.S. Cl. 725/53; 725/58; 348/731; 725/153; 348/E05.097

(57) ABSTRACT

Various embodiments described herein provide techniques for prioritizing content reception by a DVR. A DVR identifies a resource conflict between a use of a television receiving resource to receive programming currently being watched by a user and a use of the television receiving resource for receiving television programming for subsequent playback. The DVR evaluates various criteria regarding one or both uses of the television receiving resource and identifies a higher priority of one of the uses of the television receiving resource. The DVR then assigns a use of the television receiving resource according to the identified priority.

### BACKGROUND

Digital video recorders (DVRs) allow users to record television programs for later viewing. Typically, users set recording timers to record particular television programs at specified times. The DVR records a particular channel during a specified time slot corresponding with the program, e.g., 7:00 to 8:00. A DVR may have a limited number of television receiving resources (e.g., tuners) available to receive content, either to record the content for subsequent viewing or to output the content in a live mode for viewing by a user. Thus, sometimes uses of a television receiving resource may conflict when different activities require the television receiving resource at the same time.

For example, the use of a tuner to receive live broadcast content for output may conflict with the use of the tuner for receiving and recording content for subsequent playback in an overlapping time period. Thus, if a user is watching live television, then the DVR may automatically change the channel at the time specified by the recording timer in order to receive the content for recordation. The user may become annoyed if their current viewing session is interrupted in order to receive the content to be recorded. More particularly, the user may become enthralled with content being currently viewed (e.g., a sporting event or a movie) and may thus prefer that the DVR continue receiving the current programming rather than recording the other content specified by the recording timer. Some DVRs allow a user to manually override the recording timer in order to continue watching the current programming. However, the recording timer override process may interrupt the current viewing session, which is an inconvenience for the user and may further cause the user to miss portions of content while they navigate various menus in order to override the recording timer.

### BRIEF DESCRIPTION OF THE DRAWINGS

The same number represents the same element or same type of element in all drawings.

FIG. 1 illustrates an embodiment of a communication network.

FIG. 2 illustrates an embodiment of a DVR of FIG. 1.

FIG. 3 illustrates an embodiment of a time schedule for programs which may be received by the DVR of FIG. 2.

FIG. 4 illustrates an embodiment of a multiple tuner DVR of FIG. 1.

FIG. 5 illustrates an embodiment of a process for prioritizing content reception in a DVR.

### DETAILED DESCRIPTION

The various embodiments described herein generally provide apparatus, systems and methods for prioritizing content reception by a DVR. More particularly, described herein are techniques for resolving resource conflicts between multiple uses of a television receiving resource. A DVR identifies a resource conflict between a use of a television receiving resource to receive programming currently being watched by a user and a use of the television receiving resource for receiving television programming for subsequent playback. The DVR evaluates various criteria regarding one or both uses of the television receiving resource and identifies a higher priority of one of the uses of the television receiving resource. The DVR then assigns a use of the television receiving resource according to the identified priority.

In at least one embodiment, an audio/video stream to be received, processed, outputted and/or communicated may come in any format of audio, video or audio/video content. Exemplary audio/video formats include Motion Picture Experts Group (MPEG) standards, Flash, Windows Media and the like. It is to be appreciated that the audio/video stream may be supplied by any source, such as an over-the-air (OTA) broadcast, a satellite or cable television distribution system, an internet protocol television (IPTV) distribution system, a digital video disk (DVD) or other optical disk, the internet or other communication networks and the like. While the techniques illustrated herein are described in the context of reception of an audio/video stream, it is to be appreciated that the techniques may also be applied to the processing and output of other types of media content, such as audio streams or video streams, by any type of receiving device, including an audio receiver, a video receiver or any audio/video receiver.

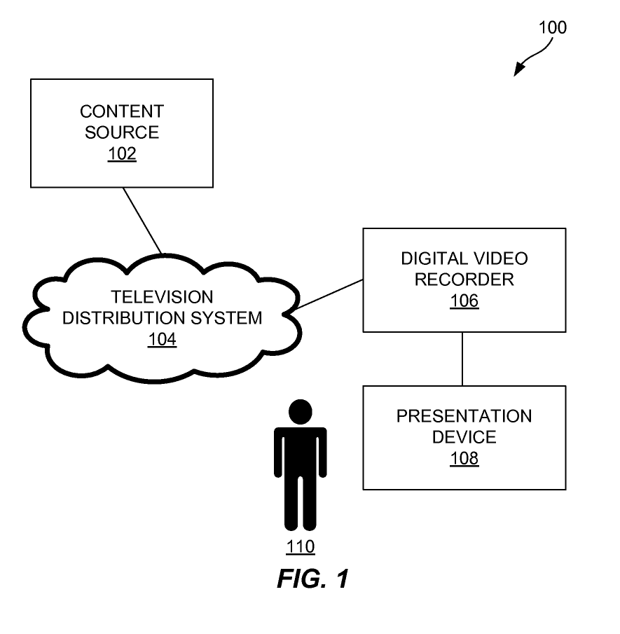

FIG. 1 illustrates an embodiment of a communication network 100. The communication network includes a content source 102, a television distribution system 104, a DVR 106 and a presentation device 108. Each of these components will be discussed in greater detail below. The communication network 100 may include other components, elements or devices not illustrated for the sake of brevity.

The content source 102 is operable for receiving, generating and communicating content to one or more DVRs 106. The content to be received, processed, outputted and/or communicated may come in any of various forms including, but not limited to, audio, video, audio/video, data, information, or otherwise. In at least one embodiment, the content source 102 is operable for receiving various forms and types of content from other sources, aggregating the content and transmitting the content to the DVR 106 through the television distribution system 104. It is to be appreciated that the content source 102 may receive practically any form and/or type of information from one or more sources including streaming television programming, recorded audio or video, electronic programming guide data and the like.

The television distribution system 104 is operable to transmit content from the content source 102 to the DVR 106. The television distribution system 104 may comprise any type of wired (e.g., cable and fiber) and/or wireless (e.g., cellular, satellite, microwave, and other types of radio frequency) communication medium and any desired network topology (or topologies when multiple mediums are utilized). Exemplary television distribution systems 104 include terrestrial, cable, satellite and internet protocol television (IPTV) distribution systems. In at least one embodiment, the television distribution system 104 broadcasts or multicasts content to a plurality of television receivers, e.g., DVR 106. The television distribution system 104 may also distribute content to a specific addressable television receiver, e.g., DVR 106, such as video-on-demand content and the like. In at least one embodiment, the content source 102 may be embodied as a transmission facility of the television distribution system 104. Exemplary content sources 102 include over-the-air (OTA) terrestrial transmission facilities, cable television distribution head-ends, satellite television uplink centers, broadband or internet servers and the like.

The DVR 106 is operable to receive content from the television distribution system 104 and output the content for presentation by the presentation device 108. For example, the DVR 106 may receive content in a live viewing mode and perform appropriate processing to format the content for presentation by the presentation device 108. In other words, the DVR 106 passes the content through to the presentation device 108 for presentation. The DVR 106 is also operable to store received content for subsequent presentation to the user 110 by the presentation device 108.

In at least one embodiment, the presentation device 108 is a display device (e.g., a television) configured to display content to a user 110. In another embodiment, the presentation device 108 comprises an audio receiver (e.g., a stereo, speaker system, headphones or the like) operable to output audio content. The DVR 106 may receive an audio, video or audio/video stream in any format (e.g., analog or digital format), and store and output the associated content for presentation by the presentation device 108. In at least one embodiment, the DVR 106 may be integrated with a television receiver, such as a satellite, cable, over-the-air, broadband or other type of television receiver that receives and demodulates television signals that are outputted for display on a display device (e.g., a television). As used herein, a television receiver or DVR may also be referred to as a set-top box, which is a television receiver that is located externally with respect to a display device. The DVR 106 may be further configured to output menus and other information that allow a user 110 to control the output of audio/video content by the DVR 106, view electronic programming guides (EPGs), set recording timers and the like. In some embodiments, the DVR 106 and the presentation device 108 may be integrated as a device combining the functionality of a display device and television receiver/DVR or the like.

In at least one embodiment, responsive to particular recording timers, the DVR 106 coordinates the reception of audio/video signals associated with a television program through a television receiving resource (e.g., a television tuner) and storage of the video signal onto a storage medium (e.g., a hard drive or Flash memory). The DVR 106 may also record content currently being broadcast responsive to input from the user 110 (e.g., the user 110 presses a record button while watching television). The DVR 106 may include any number of television receiving resources utilized for receiving television programs. A DVR 106 minimally includes at least one television receiving resource to receive and record video signals associated with a television program. The DVR 106 may include multiple television receiving resources to record multiple television programs simultaneously. For example, the DVR 106 may include two or more tuners that allow recording and/or viewing of multiple programs though the DVR 106 simultaneously. In at least one embodiment, the DVR 106 may include multiple types of television receiving resources, such as an over-the-air (OTA) tuner and a satellite and/or cable television tuner that may be utilized to receive and/or record programs from multiple sources. Responsive to a request to playback content, the DVR 106 outputs the audio/video stream to the presentation device 108 for presentation to a user 110.

In at least one embodiment, a DVR 106 is operable to assign a television receiving resource for utilization at a particular time associated with a recording timer. For example, if the DVR 106 includes one television receiving resource, then the television receiving resource will be assigned to the recording timer at the corresponding time. However, if the DVR 106 includes multiple television receiving resources, then the recording timer may be associated with a particular one of the television receiving resources. For example, the DVR 106 may include a first television receiving resource, associated with a first output to a primary presentation device. The DVR 106 may also include a second television receiving resource, associated with a second output to a secondary presentation device. Thus, the recording timer may be associated with the second television receiving resource, which may be less likely to be utilized at any particular time for a user 110 to watch live programming than the first television receiving resource.

If multiple recording timers are set at overlapping times, then each recording timer may be associated with a separate television receiving resource. For example, a first recording timer may be associated with the aforementioned first television receiving resource and a second recording timer may be associated with the second television receiving resource. The association of a recording timer to a particular television receiving resource may be performed according to various appropriate techniques. For example, the user 110 may provide appropriate input selecting a television receiving resource when setting the recording timer or the system may select one of the television receiving resources according to system rules. In at least one embodiment, the system selects an appropriate television receiving resource for a recording timer based on an analysis of the viewing history of the user 110. For example, it may be determined that the user typically utilizes the DVR 106 to watch programming on an associated primary presentation device certain times of the day, whereas the user 110 utilizes the DVR 106 to watch programming on an associated secondary presentation device at other times of the day.

At a time specified by the recording timer, the DVR 106 normally tunes the television receiving resource to a channel associated with the recording timer. The DVR 106 then begins receiving the associated audio/video stream and coordinates storage of the content to a storage medium. When the television receiving resource is not currently in use to receive content that a user 110 is watching, then there is no problem associated with the switching of the channel. In other words, if the television receiving resource is not receiving content which is currently being simultaneously output to the presentation device 108, then there is no problem. However, if the DVR 106 changes the channel being received by the television receiving resource while the user 110 is watching television, then the content output by the DVR 106 to the presentation device 108 will switch from the previous channel the user 110 was watching to the new channel being recorded. This may annoy the user 110 if they would prefer to continue watching the old channel rather than the new channel.

Thus, in accordance with the techniques described herein, the DVR 106 is operable to identify when there is a resource conflict for utilization of a television receiving resource to receive different television programs and determine which program has a higher priority for reception by the television receiving resource. More particularly, in at least one embodiment, the DVR 106 is operable to identify a resource conflict between utilization of the television receiving resource to receive a first television program specified for recording by a recording timer and a second television program currently being watched by the user 110.

If the first television program is determined to have the higher priority, then the DVR 106 operates to coordinate reception of the first television program by the television receiving resource. In other words, the DVR 106 operates to change the channel of the television receiving resource, effectively changing the content which is output to the presentation device 108 for display to the user 110. However, in at least one embodiment, if the second television program is determined to have the higher priority, then the DVR 106 operates to automatically skip the recording timer, allowing the user 110 to continue watching the second television program. In other words, the DVR 106 operates to cancel or skip the recording timer for the first television program without any input from the user 110. Thus, the user 110 continues to watch the second television program without interruption due to an automatic channel change performed by the DVR 106.

In another embodiment, the DVR 106 may operate to continue receiving and outputting the second television program using the television receiving resource and may reassign reception of the first television program to another television receiving resource. For example, the DVR 106 may include multiple television receiving resources and the first television program may be assigned for reception by a first television receiving resource. However, the first television receiving resource may be currently utilized for reception of the second television program, whereas another television receiving resource may not be currently utilized to receive any content. Thus, the DVR 106 may coordinate reception of the second television program using the other television receiving resource. This allows the DVR 106 to continue outputting the live content to the presentation device 108 for viewing by the user 110 while operating to record the content specified by the recording timer.

In at least one embodiment, the DVR 106 may operate to provide an appropriate pop-up message warning the user 110 that the recording timer is going to be skipped or reassigned to another television receiving resource for reception. For example, a popup menu may be outputted in a corner of the second television program indicating the skipping of the recording timer or the size of second television program may be temporarily shrunk to accommodate display of an appropriate message to the user 110. In at least one embodiment, the user 110 may provide appropriate input, via a remote control or the like, in order to reinstate the recording timer if they desire to record the content specified therein rather than continuing to watch the current television program.

As described above, the DVR 106 identifies relative priorities between a first television program and a second television program for reception by a television receiving resource. The priority may be determined based on various criteria, such as system or user rules, length of viewing of the live content, channels or subject matters of one or both content, analysis of user viewing histories, previous user initiated skipping of recording timers and the like. In is to be appreciated that any combination of the aforementioned criteria may be utilized in accordance with desired design criteria.

In at least one embodiment, the DVR 106 utilizes a length of viewing of the second television program (e.g., the live content) to determine whether to continue outputting the live content or switch the television receiving resource to receive the first television program. For example, if the user 110 has been watching a particular program for a significant period of time (e.g., an hour), then the live program may be assigned a higher priority than the recorded program, as the user 110 is more likely to be very engaged with the live content. By contrast, a user 110 that has been watching a particular program for a relatively short period of time (e.g., one or two minutes) may be less engaged in the program. Thus, because the user 110 is likely to be less engaged in the program and the DVR 106 may assign a higher priority to the recording timer for reception by the television receiving resource.

In at least one embodiment, the DVR 106 may assign particular time thresholds for viewing of live content which correspond with a higher priority of the live content. For example, if the user 110 has been watching live content for an hour, then the live content may automatically be assigned a higher priority than any content specified by a recording timer. In at least one embodiment, the DVR 106 may utilize a time remaining in the live content as a criteria to determine whether the live content has a higher priority. For example, if the user 110 has watched the first one and a half hours of a two hour movie, then the DVR 106 may determine that the live movie content has a higher priority than content which is to be recorded based on a recording timer. By contrast, if the user 110 has watched the middle twenty minutes of a movie, then the DVR 106 may determine that the recording timer has a higher priority than the live movie content.

In at least one embodiment, the DVR 106 may assign a higher priority to the recording timer if the user 110 has performed channel surfing in the immediate time period prior to a start time of the recording timer. For example, if the user 110 has switched channels within the last five minutes, then the DVR 106 may determine that the recorded content shall have a higher priority, since it is less likely that the user 110 is significantly engaged in the live content currently being watched due to the recent channel switch.

In at least one embodiment, the DVR 106 may assign a higher priority based on a channel associated with live content or a recording timer. For example, if the user 110 is currently watching a channel that shows predominantly sports, then it is likely that they are currently watching a sporting event. Thus, the DVR 106 may assign a higher priority to the sports channel relative to other channels. Therefore, the DVR 106 skips over the recording timer in the event of a conflict based on the higher priority of the sports content.

The DVR 106 may also base the priority determination on subject matters of the live content and the content associated with the recording timer. For example, the DVR 106 may store a subject matter classification that specifies the relative priorities of various subject matters of content. The DVR 106 may populate the subject matter classification according to user input, receive the classification from a service provider or any combination thereof. The DVR 106 then determines the priority of the live content relative to the content associated with the recording timer based on metadata associated with one or both programs. For example, the DVR 106 may process metadata specified in an electronic programming guide to determine that the live content is a sporting event and thus assign a higher priority to the live content, skipping the instance of the recording timer. In other scenarios, the content associated with a recording timer may be a news broadcast whereas the live content is a game show. Thus, the DVR 106 may determine that the news content has higher priority than the game show content and execute the recording timer rather than continuing to receive the live content.

In at least one embodiment, the DVR 106 may utilize rules, whether defined by the system, the user 110 or a content provider, to determine which television program has a higher priority. For example, the DVR 106 may utilize a rule that specifies football content always has the highest priority. In another scenario, the DVR 106 may utilize a user specified rule that the channel should never be changed automatically by the DVR 106 when the user 110 is watching a particular program. Thus, if the DVR 106 is currently outputting a particular show for viewing and a recording timer overlaps with the show, then the DVR 106 automatically skips the recording timer. In at least one embodiment, a user 110 may specify a rule when setting the recording timer that the program associated with the recording timer has the highest priority. Thus, the DVR 106 will operate to execute the recording timer regardless of what content is currently being viewed by the user 110 during the corresponding time period of the recording timer.

In at least one embodiment, the DVR 106 may operate to search an electronic programming guide for other instances of the program associated with the recording timer. If a subsequent instance of the program is located, then the DVR 106 may assign a higher priority to the live content and skip the instance of the recording timer. The DVR 106 may then automatically initiate another recording timer to record the subsequent instance of the program specified by the skipped recording timer. It is to be appreciated that various factors, such as whether the new instance of the recording timer will conflict with other recording timers may be utilized by the DVR 106 to determine the priority of the live and recorded content depending on desired design criteria. In other words, if a new instance of the recording timer cannot be set without conflicting with another recording timer, then the DVR 106 does not automatically assign a higher priority to the live content. Instead, the DVR 106 may utilize any of the criteria described above to mediate the resource conflict between the live content and the recording timer depending on desired design criteria.

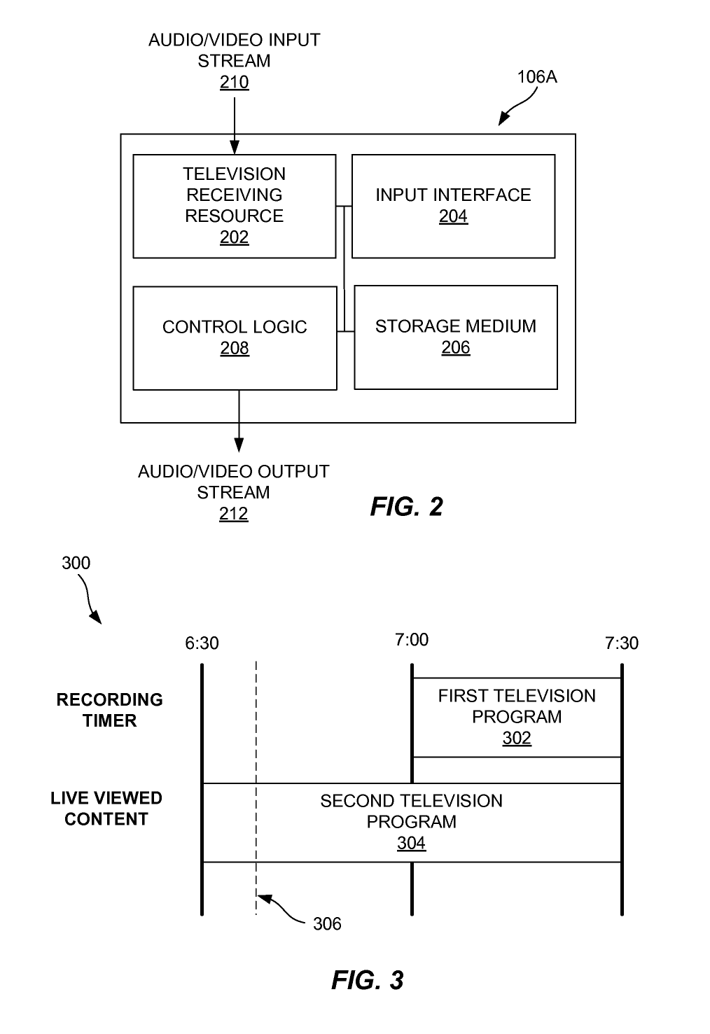

FIG. 2 illustrates an embodiment of a DVR of FIG. 1. FIG. 2 will be discussed in reference to the communication network 100 illustrated in FIG. 1. The DVR 106A includes a television receiving resource 202, an input interface 204, a storage medium 206 and control logic 208. Each of these components will be discussed in greater detail below. The DVR 106A may include other elements, components or devices which are not illustrated for the sake of brevity.

The television receiving resource 202 is operable to receive an audio/video input stream 210 from the television distribution system 104. More particularly, in at least one embodiment, the television receiving resource 202 receives and tunes a television signal including television programming. The television receiving resource 202 may receive an over-the-air (OTA) broadcast, a direct broadcast satellite signal, a cable television signal or an internet protocol television (IPTV) signal and tune the audio/video input stream 210 to extract the selected television programming. In at least one embodiment, the DVR 106A may include a plurality of television receiving resource 202, utilized by the DVR 106A to output and/or record multiple television programs simultaneously.

In at least one embodiment, the television receiving resource 202 is further operable to receive other data, such as electronic programming guide data, subject matter priority classifications or the like from the content source 102 via the television distribution system 104. In other embodiments, the DVR 106A may include a communication interface that receives the other data from a server via a separate communication network (e.g., via the internet, local area network (LAN) or wide area network (WAN), not shown in FIGS. 1-2). For example, the communication interface may comprise a network interface, such as a WiFi transceiver or Ethernet interface for communication with a communication network other than the television distribution system 104. In at least one embodiment, the television receiving resource 202 and a network interface may be combined into a single communication interface that communicates with one or more physical or logical communication networks. Furthermore, the DVR 106A may include multiple types of television receiving resources 202, such as a satellite television tuner to receive content from a satellite television distribution network and an over-the-air (OTA) television tuner to receive programming from a terrestrial broadcast system.

The input interface 204 is operable to wirelessly receive data from a remote control or other input device (not shown in FIGS. 1-2). The input interface 204 may communicate with a remote control utilizing any type of IR and/or RF communication link. In at least one embodiment, the input interface 204 receives a key code from a remote control and responsively provides the key code to the control logic 208 for processing. The data received from the remote control may be utilized by the control logic 208 to control the output of content by the control logic 208. Some of the data received by the input interface 204 may request to view electronic programming guide data, menus, set recording timers, change channels and the like.

The storage medium 206 is operable to persistently store video signals recorded by the DVR 106A. The storage medium 206 may comprise any type of non-volatile memory appropriate for storing video signals recorded by the DVR 106A. Exemplary storage mediums 206 include hard drives (e.g., magnetic memory), flash memory, battery backed up memory and the like. In at least one embodiment, the storage medium 206 may be internally located within the DVR 106A. In other embodiments, the storage medium 206 may be located external with respect to the DVR 106A. The DVR 106A may also utilize a combination of internal and external storage mediums 206 for storage of video signals.

The control logic 208 is operable to control the operation of the DVR 106A and output of content therefrom. The control logic 208 may be a single processing device or a plurality of processing devices that cooperatively operate to control the operation of the DVR 106A. The control logic 208 may include various components or modules for processing and outputting audio/video content. Exemplary components or modules for processing audio/video content include a demodulator, a decoder, a decompressor, a conditional access module and a transcoder module.

In a live mode, the control logic 208 controls the reception of specified content by the television receiving resource 202 and coordinates the output of the audio/video output stream 212 to the presentation device 108 for presentation to the user 110. For example, the user 110 may request to view a specified channel by providing input to the DVR 106A via a remote control (not shown). The remote control transmits the command to the DVR 106A requesting output of the content associated with a specified channel. The control logic 106A operates to control the television receiving resource to switch to the requested channel and receive the audio/video input stream 210 associated with the channel.

The presentation device 108 then presents the audio/video output stream 212 to the user 110. The control logic 208 may incorporate circuitry to output audio/video streams in any format recognizable by the presentation device 108, including composite video, component video, Digital Visual Interface (DVI), High-Definition Multimedia Interface (HDMI), 1394 and WiFi The control logic 208 may also incorporate circuitry to support multiple types of these or other audio/video formats. In at least one embodiment, as described above, the DVR 106A may be integrated with the presentation device 108, and the control logic 208 may be operable to control the presentation of the audio/video output stream 212 by the presentation device 108.

In a recording mode, the control logic 208 coordinates storage of the audio/video input stream 210 onto the storage medium 206 for subsequent viewing by a user 110. More particularly, the control logic 208 operates responsive to recording timers configured on the DVR 106A or other input (either supplied by a user or content provider) to command the television receiving resource 202 to receive content from a specified channel and coordinate storage of the content onto the storage medium 206.

For example, a user 110 may provide input via an electronic programming guide requesting the DVR 106A to record a particular television program. More particularly, the user 110 may provide input via the input interface (e.g., using a remote control) to select a particular program for recording. Responsive to the input, the control logic 208 sets a recording timer to receive and record the specified program as described above. The control logic 208 is further operable to retrieve stored video content from the storage medium 206 to generate the audio/video output stream 212 for display by the presentation device 108. For example, the user 110 may request to view a previously recorded program and the control logic 208 operates to retrieve and output the content to the presentation device 108.

As described above, multiple uses of the television receiving resource 202 may occasionally conflict. FIG. 3 illustrates an embodiment of a time schedule 300 for programs which may be received by the DVR 106A of FIG. 2. As illustrated in time schedule 300, a recording timer is set to record a first television program 302 broadcast on a first channel between 7:00 and 7:30. The recording timer may be set hours, day, weeks or months prior to the beginning of the first television program 302. For example, the recording timer may be a recurring instance of a timer that records each episode of a particular program. Normally, the control logic 208 would command the television receiving resource 202 (see FIG. 2) to tune to the channel associated with the first television program 302 at 7:00 and coordinate storage of the audio/video input signal 212 associated with the first television program 302 to the storage medium 206 (see FIG. 1) for subsequent viewing.

As illustrated by the time schedule 300, a second television program 304 may be available for reception by the television receiving resource 202 (see FIG. 2) on a different channel from 6:30 to 7:30. The user 110 may decide at a time 306 prior to the start of the recording timer to begin watching the second television program 304. The user 110 provides a command to the DVR 106A via the input interface 204 to initiate reception of the second television program 304 by the DVR 106A and output of the content to the presentation device 108 for viewing. In other words, the user 110 watches the second television program in a live viewing mode (e.g., as the content is being received by the DVR 106A).

Prior to the start of the first television program 302, there is no resource conflict associated with the television receiving resource 202. However, at 7:00, if the user 110 is still watching the second television program 304, then there is a resource conflict associated with the television receiving resource 202 for reception of the first and second television programs 304. The control logic 208 operates to identify the resource conflict and identifies a priority associated with one or both of the first television program 302 and the second television program 304. The priority of one or both of the first television program 302 and the second television program 304 may be determined according to any of the techniques described above in reference to FIG. 1.

In at least one embodiment, if the control logic 208 identifies that there is a higher priority for utilization of the television receiving resource 202 to receive the second television program 304 rather the first television program 302, then the control logic 208 operates to automatically skip the recording timer. Thus, the television receiving resource 202 continues to receive the second television program 304 and the first television program 302 is not recorded. However, if the control logic 208 identifies that there is a higher priority for utilization of the television receiving resource 202 to receive the first television program 302 rather the second television program 304, then the control logic 208 operates to command the television receiving resource to switch channels to receive the first television program 302 rather than the second television program 304. Thus, the control logic 208 coordinates the storage of the first television program 302 during the time period from 7:00 to 7:30. In at least one embodiment, the control logic 208 also operates to output the content of the first television program 302 for presentation by the presentation device 108.

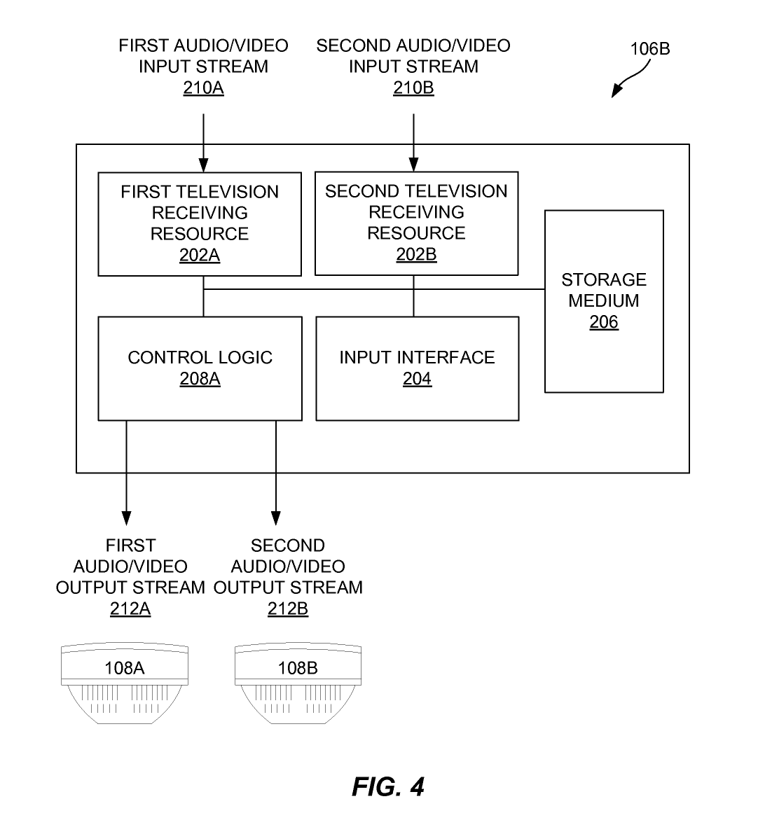

In some embodiments, a DVR may include multiple television receiving resources 202, each capable of receiving different television programs simultaneously. FIG. 4 illustrates an embodiment of a multiple tuner DVR of FIG. 1. The DVR 106B will be described in reference to the communication network 100 of FIG. 1, and includes a first television receiving resource 202A, a second television receiving resource 202B, an input interface 204, a storage medium 206 and control logic 208A. Each of these components is discussed in greater detail below and the discussion of components common to the DVR 106A (see FIG. 2) is omitted herein for the sake of brevity. Furthermore, the DVR 106B may include other components, elements or devices not illustrated for the sake of brevity.

The DVR 106B includes two separate television receiving resources 202A and 202B, each capable of receiving separate audio/video input streams 210A and 210B, respectively. The television receiving resources 202A and 202B may be similar to the television receiving resource 202 (see FIG. 2) and may receive content from any type of television distribution network. The first television receiving resource 202A and the second television receiving resource 202B may have similar or varying reception capabilities, depending on desired design criteria. For example, the first television receiving resource 202A may be capable of receiving both high definition content and standard definition content whereas the second television receiving resource 202B lacks the capability of receiving high definition content (e.g., is a standard definition tuner). In some embodiments, one or both of the first television receiving resource 202A and 202B may include capability of receiving 3-D content.

In at least one embodiment, each television receiving resource 202A and 202B is operable to receive content which may be stored on the storage medium 206. In at least one embodiment, each television receiving resource 202A and 202B may be configured to receive content which is output to a specified presentation device 108A and 108B. For example, the first television receiving resource 202A may be configured to receive content which is output to a first presentation device 108A and the second television receiving resource 202B may be configured to receive content which is output to a second presentation device 108B. In at least one embodiment, the control logic 208A is operable to dynamically assign the input of a particular television receiving resource 202A and 202B for output to a specific presentation device 108A and 108B.

The control logic 208A is similar to the control logic 208 (see FIG. 2) and is operable to control the reception of a first audio/video input stream 210A by the first television receiving resource 202A. The control logic 208A may then coordinate the output of the associated content to the first presentation device 108A via the first audio/video output stream 212A and may also coordinate the storage of the associated content to the storage medium 206. Similarly, the control logic 208A may coordinate the reception of the second audio/video input stream 210B by the second television receiving resource 202B and may coordinate the storage of the associated content to the storage medium 206 or the output of the content to the second presentation device 108B via the second audio/video output stream 212B.

In at least one embodiment, the control logic 208A may receive a request to record a first television program utilizing the first television receiving resource 202A. The control logic 208A operates responsive to the request to set a recording timer to receive the first television program utilizing the first television receiving resource 202A and coordinate storage of the first television program to the storage medium 206.

However, prior to the start time associated with the recording timer, the control logic 208A may receive a command to utilize the first television receiving resource 202A to receive a second television program for immediate output to the second presentation device 108A. For example, the user 110 (see FIG. 1) may request to view the second television program (e.g., a football game) an hour before the start time of the recording timer for the first television program.

If the first television receiving resource 202A is still receiving the second television program at the start time associated with the recording timer, then the control logic 208A identifies a resource conflict for utilization of the first television receiving resource to receive the first television program and the second television program. The control logic 208A may then determine which of the programs has the highest priority for reception by the first television receiving resource 202A. For example, the second television program (e.g., the live viewed content) may have a higher priority by virtue of the fact that the content is a football game.

The control logic 208A may then determine that the first television receiving resource 202A should be utilized to continue receiving the second television program. However, the control logic 208A may further identify an availability of the second television receiving resource to receive the first television program. In other words, the second television receiving resource 202B may not be currently utilized to receive any content and may thus be available to receive the first television program.

If the second television receiving resource 202B is available to receive the first television program, then the control logic 208A may automatically coordinate the reception of the first television program by the second television receiving resource 202B and the storage of the first television program to the storage medium 206. Thus, the user 110 may continue to watch the second television program on the presentation device 108A uninterrupted and the first television program is received and recorded through a different television receiving resource. If the first and second television receiving resources 202A and 202B have varying capabilities, then the second television program may not be recorded in the optimal desired format when reception is switched from the first television receiving resource 202A to the second television receiving resource 202B. However, the first television receiving resource is nonetheless recorded by the DVR 106B while not interrupting the viewing of the second television program by the user 110. This is especially beneficial when the second television program comprises more desirable content that the user 110 would rather watch uninterrupted in the live viewing mode rather than having the first television program recorded in the optimal format.

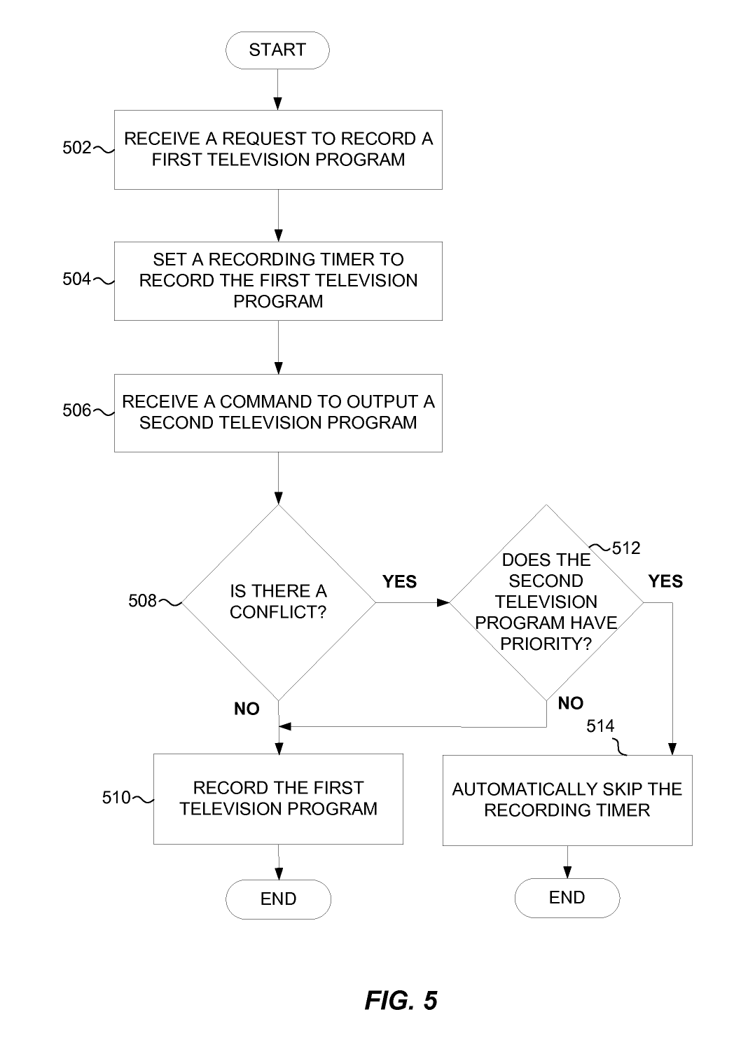

FIG. 5 illustrates an embodiment of a process for prioritizing content reception in a DVR. The process of FIG. 5 may include other operations not illustrated for the sake of brevity.

The process includes receiving a request at a DVR to record a first television program utilizing a television receiving resource (operation 502). The process further includes setting a recording timer on the DVR to receive the first television program utilizing the television receiving resource and storing the first television program to a storage medium (operation 504).

The process further includes receiving a command, prior to a time associated with the recording timer, to utilize the television receiving resource to output a second television program for presentation by a presentation device (operation 506). At a time specified by the recording timer, the process includes determining whether there is a resource conflict for utilization of the television receiving resource (operation 508). If there is no conflict identified, then processing continues in operation 510, and the DVR operates to record the first television program.

If operation 508 results in an identification of a resource conflict for utilization of the television receiving resource to receive the first television program and the second television program, then processing continues in operation 512. In operation 510, the process includes identifying whether there is a higher priority to utilize the television receiving resource to receive the first television program or the second television program. Any of the criteria described above may be utilized to determine which program has a higher priority for reception by the television receiving resource.

If the first television program has a higher priority, then processing continues in operation 510 and the television receiving resource is switched to receive and record the first television program. If the second television program has a higher priority, then processing continues in operation 514 and the recording timer is automatically skipped so that the television receiving resource continues to receive the second television program.

Although specific embodiments were described herein, the scope of the invention is not limited to those specific embodiments. The scope of the invention is defined by the following claims and any equivalents therein.

What is claimed is:

1. A method for prioritizing content reception in a digital video recorder, the method comprising:
receiving a request at a digital video recorder to record a first television program utilizing a television receiving resource;
setting a recording timer on the digital video recorder to receive the first television program utilizing the television receiving resource and store the first television program to a storage medium;
receiving a command, prior to a time associated with the recording timer, to utilize the television receiving resource to output a second television program for presentation by a presentation device;
at a time specified by the recording timer, identifying a resource conflict for utilization of the television receiving resource to receive the first television program and the second television program;
identifying a higher priority for utilization of the television receiving resource to receive the second television program rather than the first television program; and
automatically skipping the recording timer responsive to identifying the higher priority of the second television program.

2. The method of claim 1, wherein identifying the higher priority comprises:
identifying the higher priority of the second television program based on a first subject matter of the second television program.

3. The method of claim 2, wherein identifying the higher priority comprises:
identifying the higher priority of the second television program further based on a second subject matter of the first television program.

4. The method of claim 3, wherein identifying the higher priority comprises:
identifying the higher priority of the second television program based on a subject matter priority classification designated by a service provider, the first subject matter having a higher priority in the subject matter priority classification than the second subject matter.

5. The method of claim 3, wherein identifying the higher priority comprises:
identifying the higher priority of the second television program based on a subject matter priority classification designated by a user of the digital video recorder, the first subject matter having a higher priority in the subject matter priority classification than the second subject matter.

6. The method of claim 1, wherein identifying the higher priority comprises:
identifying the higher priority of the second television program based on an elapsed viewing time of the second television program.

7. The method of claim 1, wherein identifying the higher priority comprises:
identifying the higher priority of the second television program based on a broadcast channel of the second television program.

8. The method of claim 1, wherein identifying the higher priority comprises:
identifying the higher priority of the second television program based on a user designated rule regarding the second television program.

9. The method of claim 1, wherein identifying the higher priority and automatically skipping the recording timer comprises:
searching an electronic programming guide to identify another broadcast instance of the second television program at a different time; and
setting a second recording timer to record the first television program at the different time.

10. A digital video recorder comprising:
a television receiving resource;
a storage medium;
an input interface; and
control logic operable to:
receive a request to record a first television program utilizing the television receiving resource;
set a recording timer to receive the first television program utilizing the television receiving resource and coordinate storage of the first television program to the storage medium;
receive a command, via the input interface, prior to a time associated with the recording timer, to utilize the television receiving resource to output a second television program for presentation by a presentation device;
at a time specified by the recording timer, identify a resource conflict for utilization of the television receiving resource to receive the first television program and the second television program;
identify a higher priority for utilization of the television receiving resource to receive the second television program rather than the first television program; and
automatically skip the recording timer responsive to identifying the higher priority of the second television program.

11. The digital video recorder of claim 10, wherein the control logic is operable to identify the higher priority of the second television program based on a first subject matter of the second television program.

12. The digital video recorder of claim 11, wherein the control logic is operable to identify the higher priority of the second television program further based on a second subject matter of the first television program.

13. The digital video recorder of claim 12, wherein the control logic is operable to identify the higher priority of the second television program based on a subject matter priority classification designated by a service provider, the first subject matter having a higher priority in the subject matter priority classification than the second subject matter.

14. The digital video recorder of claim 12, wherein the control logic is operable to identify the higher priority of the second television program based on a subject matter priority classification designated by a user of the digital video recorder, the first subject matter having a higher priority in the subject matter priority classification than the second subject matter.

15. The digital video recorder of claim 10, wherein the control logic is operable to identify the higher priority of the second television program based on an elapsed viewing time of the second television program.

16. The digital video recorder of claim 10, wherein the control logic is operable to identify the higher priority of the second television program based on a broadcast channel of the second television program.

17. The digital video recorder of claim 10, wherein the control logic is operable to identify the higher priority of the second television program based on a user designated rule regarding the second television program.

18. The digital video recorder of claim 10, wherein the control logic is operable to search an electronic programming guide to identify another broadcast instance of the second television program at a different time and set a second recording timer to record the first television program at the different time.

19. A digital video recorder comprising:
a first television receiving resource;
a second television receiving resource;
a storage medium;
an input interface; and
control logic operable to:
receive a request to record a first television program utilizing the first television receiving resource;
set a recording timer to receive the first television program utilizing the first television receiving resource and coordinate storage of the first television program to the storage medium;
receive a command, via the input interface, prior to a time associated with the recording timer, to utilize the first television receiving resource to output a second television program for presentation by a presentation device;
at a time specified by the recording timer, identify a resource conflict for utilization of the first television receiving resource to receive the first television program and the second television program;
identify a higher priority for utilization of the first television receiving resource to receive the second television program rather than the first television program;
identify an availability of the second television receiving resource to receive the first television program; and
automatically coordinate the reception of the first television program by the second television receiving resource and storage of the first television program to the storage medium.

20. The digital video recorder of claim 19, wherein the first television receiving resource comprises a high definition television tuner and the second television receiving resource comprises a standard definition television tuner.
